(19) United States
(12) Patent Application Publication
(10) Pub. No.: US 2012/0145275 A1
(43) Pub. Date: Jun. 14, 2012

(54) HOSE HAVING MEDIA-RESISTANT INNER LAYER, APPLICATION AND METHOD FOR PRODUCTION THEREOF

(76) Inventors: Uwe Seebold, Witzenhausen (DE); Ligia Ludwig, Kassel (DE); Michael Sont, Horneburg (DE)

(21) Appl. No.: 13/359,779

(22) Filed: Jan. 27, 2012

Related U.S. Application Data
(63) Continuation of application No. PCT/EP2010/058686, filed on Jun. 21, 2010.

(30) Foreign Application Priority Data
Jul. 27, 2009 (DE) 10 2009 026 254.7

(51) Int. Cl. F16L 11/04; D01D 5/24

(52) U.S. Cl. 138/137; 264/209.6

(57) ABSTRACT

A hose has at least the following layer structure: an inner layer made of an amine-bonded rubber mixture having media-resistance properties and an adhesion layer of a peroxide-bonded rubber mixture lying on the external side of the inner layer. The inner layer and the adhesion layer form an adhesive bond. The inner layer includes a rubber mixture based on unblended AEM or an AEM blend or on unblended ACM or an ACM blend and the adhesion layer includes a rubber mixture based on EPM or EPDM, each of which are unblended. The hose often includes a strengthening support layer and an external layer of a rubber mixture having resistance to external influences. The external layer preferably includes a peroxide-bonded rubber mixture based on unblended EPM or an EPM blend or on unblended EPDM or an EPDM blend.

### CROSS REFERENCE TO RELATED APPLICATIONS

This application is a continuation application of international patent application PCT/EP 2010/058686, filed Jun. 21, 2010, designating the United States and claiming priority from German application 10 2009 026 254.7, filed Jul. 27, 2009, and the entire content of both applications is incorporated herein by reference.

### FIELD OF THE INVENTION

The invention relates to a hose with at least the following layer structure:
an internal layer made of an aminically crosslinked rubber mixture with properties of resistance to the substances to be conveyed; and,
an adhesive layer made of a peroxidically crosslinked rubber mixture which is in contact with the external side of the internal layer, where the internal layer and the adhesive layer form an adhesive bond.

### BACKGROUND OF THE INVENTION

In the past, much attention has been given to the development of the internal layer with properties of resistance to the substances to be conveyed, for example resistance to oils, fuels, chemicals, coolants, and gases, and this type of development will continue against the background of increasingly stringent requirements, inter alia with respect to additional barrier layers, in particular for gases. Reference is made by way of example to the following literature for the relevant prior art: DE 88 05 593 U1; DE 20 2004 020 354 U1; DE 42 15 778 A1; DE 10 2008 014 988 A1; U.S. Pat. No. 6,089,277; EP 0 826 915 A2; EP 1 764 211 A1; EP 1 546 595 B1; WO 2007/045322 A1; U.S. Pat. No. 4,998,564; U.S. Pat. No. 5,718,957; and, United States patent application publication 2005/0205149 A1.

More details of the prior art for charge-air hoses are given below, and particular reference is made here to the laid-open specification WO 2007/045322 A1.

Internal combustion engines for motor vehicles are divided according to their design into naturally aspirated engines in which hoses pass unpressurized air to the intake manifold and forced-induction engines using dynamic or external forced induction. In the case of engines with external forced induction, pressurized and heated air is fed through pipes and hoses to the cylinders downstream of the turbocharger, as is the case for example when an exhaust gas turbocharger is used. The advantages of forced induction to the engine, for example, increased engine power and engine torque, reduced fuel consumption, and reduced emissions of hazardous substances, can be further increased by cooling the charge air through a charge-air cooler between exhaust gas turbocharger and cylinder. Whereas exhaust gas turbochargers are components fixedly mounted on the engine, charge-air coolers have hitherto been secured to the bodywork. The charge-air hoses used for engines with charge-air cooling therefore have to compensate the relative movements between engine and bodywork.

Hoses for feeding air to engines of motor vehicles are divided, according to the nature of the air to be conveyed, into clean-air hoses and hoses for conveying air contaminated by engine oil, fuel vapor, fuel condensate, and exhaust gases from crank-case venting, from exhaust gas recirculation, and from the lubrication of the exhaust gas turbocharger. Charge-air lines and charge-air hoses have to be chemically resistant to engine oil and to pressurized and heated air, the temperature and pressure of which depend on the charge pressure and the charge-air cooling system. Compensation of assembly tolerances, absorption of relative movements between exhaust gas turbocharger/-charge-air cooler, and charge-air cooler/engine, and acoustic damping can be provided only by charge-air hoses that have dynamic stability.

In the prior art, charge-air hoses are produced from a crosslinked rubber mixture based on AEM (trade name “VAMAC”), and indeed this applies not only to the internal layer but also to the external layer. They feature good seating properties together with high dynamic functionality, but only if aminic crosslinking is used.

Charge-air hoses made of AEM with peroxidic crosslinking do not comply with the requirements relating to seating properties and dynamic functionality.

Charge-air hoses in which both the internal layer and the external layer are composed of an aminically crosslinked AEM rubber mixture in turn feature the following disadvantages:
High materials costs arise for the AEM mixture(s) if internal layer and external layer have different structure.
Low flexibility arises at temperatures below −35° C.
The hoses have to be postvulcanized in hot air if good seating properties are to be obtained.
The marked temperature dependency of the viscosity of an AEM mixture makes it more difficult to comply with narrow wall thickness tolerances during crosshead extrusion of the external layer.

The problems indicated here which apply to charge-air hoses are in principle relevant to all hoses based on aminically crosslinked AEM material.

Patent specification EP 1 546 595 B1 then proposes a hose, in particular a charge-air hose, which is intended to eliminate the abovementioned disadvantages. Its internal layer is composed of an aminically and/or peroxidically crosslinked rubber mixture based on AEM, ACM, or EVA. Between the internal layer and the external layer, the arrangement has an adhesive layer (intermediate layer) which is composed of a peroxidically crosslinked mixture of materials. Said mixture of materials is based on a rubber blend mixture, in particular based on an AEM/EPDM blend. However, there is an associated conflict here, to which some reference has already been made above:
Aminic crosslinking is advantageous for AEM, since it is associated with good seating properties together with high dynamic functionality. However, a problem which then arises is the incompatibility of AEM and EPDM. Peroxidic crosslinking solves this incompatibility problem.
AEM hoses with peroxidic crosslinking in turn fail—as previously mentioned—to comply with the requirements relating to seating properties and dynamic functionality.

In the light of all of the problems described here and of the conflict inherent in the objectives disclosed in patent specification EP 1 546 595 B1, the object of the invention consists in providing a hose of this generic type which features firstly an internal layer resistant to the substances to be conveyed and secondly an adhesive layer adhesively bonded to the internal layer, where said two base layers form the basis for a versatile hose structure, with a specific view to a variety of possible applications.

### SUMMARY OF THE INVENTION

Said object is achieved in that
the internal layer is composed of a rubber mixture based on unblended AEM or on an AEM blend, or on unblended ACM or on an ACM blend; and,
the adhesive layer is composed of a rubber mixture based on EPM or EPDM, in each case unblended.

Particular significance is attached to an internal layer based on AEM material or on blended AEM material, specifically with a view to compatibility with another rubber component. The simple variant using unblended material is mostly adequate.

For the purposes of simple hose design, the adhesive layer can simultaneously form the external layer without any further layers superposed thereon, especially since EPM and EPDM feature high resistance to aging, to weathering, and to heat together with good low-temperature flexibility. These types of material protect the hose from exterior effects. However, this type of hose is used only when the substance to be conveyed is not a pressurized substance.

However, the hose is mostly provided with an external layer, in particular in conjunction with an embedded single- or multiple-ply reinforcing layer. The substance to be transported can thus be a pressurized substance. In this type of hose structure the adhesive layer takes the form of intermediate layer, specifically between the internal layer and the reinforcing layer or the external layer.

The external layer here is composed of a peroxidically crosslinked rubber mixture, in particular based on unblended EPM or on an EPM blend or on unblended EPDM or on an EPDM blend. In the case of the blend variant, a particular role is played by an EPM/EPDM blend with various proportions, for example, an EPM/EPDM blend with 30 phr of EPM and 70 phr of EPDM. However, the version using unblended material is mostly preferred. The particular advantages of EPM and EPDM in respect of exterior effects have been mentioned above.

The reinforcing layer has been formed from a woven or knit, in particular based on a textile material. The materials relevant here can be a polyamide (PA), a polyimide (PI), an aramid, in particular para-aramid or meta-aramid, a polyvinyl acetal (PVA), a polyether ether ketone (PEEK), a polyester, in particular polyethylene terephthalate (PET) or polyethylene 2,6 naphthalate (PEN), a polysulfone (PSU), or a polyphenylene or polyphenylene derivative, in particular a polyphenylene sulfide (PPS). It is also possible to use hybrid designs, for example taking the form of a mixed yarn. By way of example, a hybrid design made of PPS and PA is used for the purposes of a hose developed relatively recently (DE 10 2008 037 417.2). PPS is a high-performance material and contributes to high strength, while PA contributes not only to reinforcement but also, because it can be activated to provide adhesion, to improved adhesion with respect to the surrounding elastomeric material. In this context, the reinforcing layer is mostly in direct contact with the adhesive layer (intermediate layer) on one side and with the external layer on the other side, specifically with formation of an adhesive bond.

The crosslinking of the internal layer, adhesive layer or intermediate layer, and external layer is of essential significance and in particular involves a crosslinking agent system comprising a crosslinking agent and an accelerator or activator, and further detail is therefore given below concerning the crosslinking of the individual layers.

### Internal Layer

The internal layer is an aminically crosslinked layer, preferably involving exclusively aminic crosslinking. Patent specification EP 1 546 595 B1 describes the use of an aminic and/or peroxidic crosslinking agent, but details have been given above in the introduction concerning the disadvantages of peroxidic crosslinking of AEM-based rubber mixtures. Even a small proportion of peroxides, alongside the aminic crosslinking agent, is disadvantageous.

The aminic crosslinking agent is in particular a diamine, and HMD and/or HMDC is/are in particular used here. The proportion of the aminic cross-linking agent is from 0.3 phr to 2.1 phr, in particular from 0.8 phr to 1.6 phr, more particularly from 1.0 phr to 1.4 phr.

The accelerator or activator is a base, for example DPG, but in particular DBU or a DBU derivative. Reference is made in this connection to the relatively recent development in DE 10 2008 055 525.8. DBU replaces DOTG, which has hitherto often been used as accelerator but which has been classified as toxic and carcinogenic. DBU, in particular in conjunction with HMD and/or HMDC, and more particularly with HMDC, provides an ideal effect in terms of vulcanization rate and in terms of the shelf life of an AEM rubber mixture or ACM rubber mixture. The quantitative proportion of the accelerator is from 0.5 phr to 2.4 phr, in particular from 0.8 phr to 2.0 phr, more particularly from 1.0 phr to 1.8 phr.

### Adhesive Layer or Intermediate Layer

The peroxidic crosslinking agent for the rubber mixture of the adhesive layer or intermediate layer is preferably an alkyl aralkyl peroxide and/or a diaralkyl peroxide and/or a peroxyketal and/or a peroxyester. Particular importance is attached to the use of dicumyl peroxide and/or
bis(tert-butylperoxyisopropyl)benzene and/or 2,5
bis(tert-butylperoxy)-2,5-dimethylhexane. The proportion of the peroxidic crosslinking agent is from 3.0 phr to 10.0 phr, in particular from 4.5 phr to 8.5 phr, more particularly from 5.5 phr to 7.5 phr.

The activator is in particular an allyl compound and/or an acrylate and/or a diacrylate and/or a methacrylate and/or BR, in particular here in the form of 1,2-BR, and/or N,N′-m-phenylene-dimaleimide. From the group of the allyl compounds, particular mention may be made here of TAC, and also of derivatives. Compounds which play a role within the entire group of the acrylates, diacrylates, and methacrylates are not only the esters, such as MMA, but also the salt compounds, in particular in the form of zinc salt compounds. ZDMA is of particular importance. The quantitative proportion of the activator is from 0.1 phr to 20.0 phr, in particular from 1.0 phr to 15.0 phr, more particularly from 5.0 phr to 15.0 phr.

### External Layer

The information applicable to the peroxidically crosslinked rubber mixture in conjunction with the preferred hose structure made of internal layer, adhesive layer (intermediate layer), and external layer is the same as that provided for the adhesive layer or intermediate layer discussed above, specifically both in relation to the preferred types of substance for the crosslinking agent and activator and in relation to the quantitative proportions of these.

The rubber mixture of the internal layer and of the adhesive layer or intermediate layer, and of the external layer, comprises not only the crosslinking agent or crosslinking agent system but also further mixture ingredients. These comprise in particular a filler and/or a metal oxide and/or a plasticizer and/or a processing aid and/or an antioxidant and/or an adhesive. However, there is mostly at least one filler incorporated into the mixture.

The filler is a carbon black, for example an SAF carbon black, HAF carbon black, FF carbon black, FEF carbon black or lamp black, and/or a silica and/or a silicate and/or chalk and/or kaolin. Particular silicates that may be mentioned are an aluminum silicate and/or calcium silicate and/or a magnesium silicate. However, there is mostly at least one carbon black incorporated into the mixture.

Among the metal oxides, a particular role is played by CaO and/or MgO and/or ZnO.

The plasticizer is a mineral oil plasticizer and/or a polymer plasticizer and/or an ester plasticizer.

The adhesive comprises a tackifier and/or an adhesion promoter, for example a resin. It is thus possible that the internal layer and the adhesive layer or the intermediate layer, free from any additional application of adhesion promoter, form an adhesive bond. In one alternative, an adhesion-agent solution or a solvent can also be applied between said two layers.

The total quantitative proportion of the mixture ingredients, specifically without the crosslinking agent or the crosslinking agent system, is from 50 phr to 400 phr, in particular from 80 phr to 160 phr.

In relation to other aspects of the mixture ingredients, reference is made to the general prior art in rubber mixture technology.

Key to abbreviations used here:

| AEM | Ethylene-acrylate rubber | | |
|---|---|---|---|
| ACM | Acrylate rubber | | |
| EPM | Ethylene-propylene rubber | | |
| EPDM | Ethylene-propylene-diene rubber | | |
| EVA | Ethylene-vinyl acetate rubber | | |
| BR | Butadiene rubber | | |
| HMD | Hexamethylenediamine | | |
| HMDC | Hexamethylenediamine carbamate | | |
| DBU | 1,8-Diazabicyclo[5.4.0]undec-7-ene | | |
| DOTG | Di-ortho-tolylguanidine | | |
| DPG | Diphenylguanidine | | |
| TAC | Triallyl cyanurate | | |
| MMA | Methyl methacrylate | | |
| ZDMA | Zinc dimethacrylate | | |
| SAF | Super abrasion | | abbreviations for types of |
| | | {close oversize brace} | |
| HAF | High abrasion | | carbon black in Römpps Chemie- |
| | | | Lexikon [Römpp's chemical |
| | | | encyclopedia], volume 5, 1987 |
| FF | Fine | | abbreviations for types of |
| FEF | Fast extrusion | {close oversize brace} | carbon black in Römpps Chemie- |
| GBF | General purpose | | Lexikon [Römpp's chemical |
| | | | encyclopedia], volume 5, 1987 |

| | |
|---|---|
| phr | per hundred rubber |

The hose of the invention is used as follows to transport a substance to be conveyed:
The hose is used for transporting a liquid, in particular an oil or fuel. The oils are more particularly engine oils, transmission oils, hydraulic oils, or power-steering-system oils.
The hose is used for transporting a gas with or without any additives. Mention may be made here of the transport of clean air, and also of air contaminated by engine oil, by fuel vapor, by fuel condensate, by exhaust gas or by blow-by gases. Mention may also be made of the transport of air under static or cyclic superatmospheric pressure, and also of the transport of air when there are relative movements of hose nozzles with respect to one another.
A prominent field of application is the charge-air hose. Reference is in particular made to the laid-open specification WO 2007/045322 A1 in relation to the relevant technology.
The hose can also be used as linear hose, curved hose, or distribution hose respectively with smooth and/or folded surface.
Finally, mention may also be made of the use of the hose of the invention for the purposes of a hose arrangement comprising the hose and at least one additional component. The hose here is used in particular in combination with a Henn connector, with a VDA coupling, with a pipe nozzle with securing elements, or with abrasion protection, or with a hose clamp.

Another object of the invention consists in providing a process which can produce a hose of this generic type in a manner which is simple and also inexpensive.

The following three process variants are used in relation to the internal layer and to the adhesive layer or intermediate layer bonded thereto:

### Variant A

The internal layer made of the aminically crosslinkable rubber mixture and the adhesive layer made of the peroxidically crosslinkable rubber mixture are formed in succession via extrusion.

### Variant B

The internal layer and the adhesive layer with the crosslinkable rubber mixtures as in variant A are formed via coextrusion.

### Variant C

The internal layer and the adhesive layer with the crosslinkable rubber mixtures as in variant A are respectively formed via calendering.

After the process substeps as in variants A, B, and C, the hose is then finished, specifically as follows:
In conjunction with claim 2, the unvulcanized hose made of internal layer and adhesive layer is vulcanized without reinforcing layer and external layer. The adhesive layer here also functions as the external layer.
In conjunction with claim 5, the unvulcanized hose made of internal layer and adhesive layer is further processed with the reinforcing layer and with the external layer, with attendant final vulcanization.

The single- or multiple-ply reinforcing layer can by way of example be introduced by means of knitting processes, winding processes, or braiding processes. Winding processes using wovens coated by rubber mixtures can also be used. It is also possible to use a combination of extrusion processes and winding processes. In this connection, reference is made to the general prior art in process technology for producing textile-reinforced hoses.

### BRIEF DESCRIPTION OF THE DRAWING

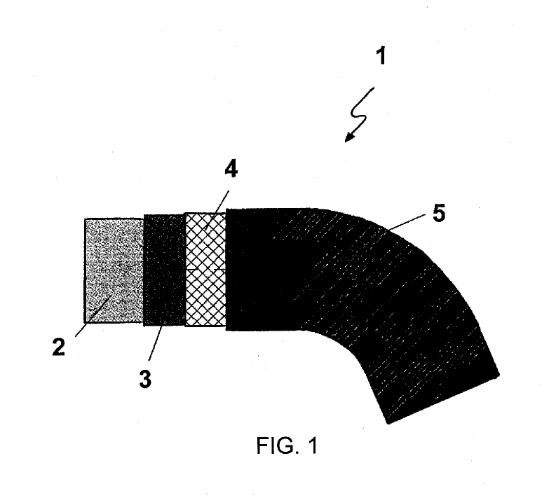

The invention will now be described with reference to the single FIGURE of the drawing (FIG. 1) which shows a hose 1 in the form of curved hose used in charge-air technology. The hose here has the following layer structure designed with the following materials by way of example:

Internal layer 2: Aminically crosslinked unblended AEM rubber mixture
Adhesive layer 3: Peroxidically crosslinked unblended EPDM rubber mixture
Reinforcing layer 4: Aramid textile filaments
External layer 5: Peroxidically crosslinked unblended EPDM rubber mixture

### DESCRIPTION OF THE PREFERRED EMBODIMENTS OF THE INVENTION

In this inventive example, the adhesive layer 3 represents an intermediate layer, and forms an adhesive bond with the internal layer 2.

If the hose is not subject to any stringent pressure requirements, the adhesive layer 3 can simultaneously form the external layer.

It is understood that the foregoing description is that of the preferred embodiments of the invention and that various changes and modifications may be made thereto without departing from the spirit and scope of the invention as defined in the appended claims.

### Key

### PART OF DESCRIPTION

1 Hose
2 Internal layer
3 Adhesive layer (intermediate layer)
4 Reinforcing layer
5 External layer

What is claimed is:

1. A hose with at least the following layer structure:
an internal layer made of an aminically crosslinked rubber mixture with properties of resistance to substances to be conveyed, and
an adhesive layer made of a peroxidically crosslinked rubber mixture which is in contact with an external side of the internal layer, where the internal layer and the adhesive layer form an adhesive bond;
wherein
the aminically crosslinked rubber mixture is selected from the group consisting of unblended ethylene-acrylate rubber (AEM), an AEM blend, unblended acrylate rubber (ACM), and an ACM blend, and
the peroxidically crosslinked rubber mixture is selected from the group consisting of ethylene-propylene rubber (EPM) and ethylene-propylene-diene rubber (EPDM), in each case unblended.

2. The hose as claimed in claim 1, wherein the adhesive layer simultaneously forms the external layer of the hose.

3. The hose as claimed in claim 1, wherein the hose further comprises an external layer made of a peroxidically crosslinked rubber mixture with resistance toward exterior effects, where the adhesive layer serves as an intermediate layer.

4. The hose as claimed in claim 3, wherein the external layer is composed of a rubber mixture selected from the group consisting of unblended EPM, an EPM blend, unblended EPDM, and an EPDM blend.

5. The hose as claimed in claim 3, wherein a single- or multiple-ply reinforcing layer has been arranged between the adhesive layer and the external layer.

6. The hose as claimed in claim 5, wherein the reinforcing layer has been formed from a woven, a knitted, or a knotted fabric.

7. The hose as claimed in claim 5, wherein the material of the reinforcing layer is selected from the group consisting of a polyamide, a polyimide, a polysulfone, an aramid, in particular para-aramid or meta-aramid, a polyvinyl acetal, a polyether ether ketone, a polyester, a polyphenylene, and a polyphenylene derivative, or a hybrid design involving the above-mentioned materials.

8. The hose as claimed in claim 5, wherein the reinforcing layer is in direct contact with the adhesive layer on one side and with the external layer on the other side, with formation of an adhesive bond.

9. The hose as claimed in claim 1, wherein the internal layer is composed of a rubber mixture based on unblended AEM or on an AEM blend.

10. The hose as claimed in claim 1, wherein the internal layer is composed of a rubber mixture which is free from any peroxidic crosslinking agent, so that it is exclusively the aminic crosslinking agent that is active.

11. The hose as claimed in claim 1, wherein the aminic crosslinking agent for the rubber mixture of the internal layer is a diamine.

12. The hose as claimed in claim 11, wherein the diamine is hexamethylene diamine (HMD) and/or hexamethylenediamine carbamate (HMDC).

13. The hose as claimed in claim 1, wherein an amount of the aminic crosslinking agent present for the rubber mixture of the internal layer is from 0.3 phr to 2.1 phr.

14. The hose as claimed in claim 1, wherein the aminic crosslinking agent for the rubber mixture of the internal layer forms, with an accelerator, a crosslinking agent system.

15. The hose as claimed in claim 14, wherein the accelerator has basic character.

16. The hose as claimed in claim 14, wherein the accelerator is 1,8-diazabicyclo[5.4.0]undec-7-ene (DBU) or a DBU derivative.

17. The hose as claimed in claim 14, wherein the amount present of the accelerator is from 0.5 phr to 2.4 phr.

18. The hose as claimed in claim 1, wherein the peroxidic crosslinking agent for the rubber mixture of the adhesive layer and/or of the external layer is selected from the group consisting of an alkyl aralkyl peroxide, a diaralkyl peroxide, a peroxyketal and a peroxyester, or a mixture thereof.

19. The hose as claimed in claim 18, wherein the peroxidic crosslinking agent is selected from the group consisting of dicumyl peroxide, bis(tert-butylperoxyisopropyl)-benzene, and 2,5-bis(tert-butylperoxy)-2,5 dimethylhexane, or a mixture thereof.

20. The hose as claimed in claim 1, wherein the amount present of the peroxidic crosslinking agent for the rubber mixture of the adhesive layer and/or of the external layer is from 3.0 phr to 10.0 phr.

21. The hose as claimed in claim 1, wherein the peroxidic crosslinking agent for the rubber mixture of the adhesive layer and/or of the external layer forms, with an activator, a crosslinking agent system.

22. The hose as claimed in claim 21, wherein the activator is selected from the group consisting of an allyl compound, an acrylat, a diacrylate, a methacrylate, a butadiene rubber (BR), and a N,N′-m-phenylenedimaleimide, or a mixture thereof.

23. The hose as claimed in claim 22, wherein the allyl compound is based on cyanurates.

24. The hose as claimed in claim 22, wherein the acrylate and/or the diacrylate and/or the methacrylate is an ester.

25. The hose as claimed in claim 22, wherein the acrylate and/or the diacrylate and/or the methacrylate is a salt compound.

26. The hose as claimed in claim 25, wherein the acrylate and/or the diacrylate and/or the methacrylate is a zinc salt compound.

27. The hose as claimed in claim 22, wherein the BR is 1,2-BR.

28. The hose as claimed in claim 21, wherein the amount present of the activator for the rubber mixture of the adhesive layer and/or of the external layer is from 0.1 phr to 20.0 phr.

29. The hose as claimed in claim 1, wherein the rubber mixture of the internal layer and of the adhesive layer and of the external layer comprises further mixture ingredients alongside the crosslinking agent or crosslinking agent system.

30. The hose as claimed in claim 29, wherein the mixture ingredients comprise a filler and/or a metal oxide and/or a plasticizer and/or a processing aid and/or an antioxidant and/or an adhesive.

31. The hose as claimed in claim 30, wherein the mixture ingredients comprise at least one filler.

32. The hose as claimed in claim 30, wherein the filler is selected from the group consisting of a carbon black, a silica, a silicate, chalk, and kaolin, or a mixture thereof.

33. The hose as claimed in claim 32, wherein the filler is at least one carbon black.

34. The hose as claimed in claim 32, wherein the silicate is selected from the group consisting of an aluminum silicate, a calcium silicate, and a magnesium silicate, or a mixture thereof.

35. The hose as claimed in claim 30, wherein the metal oxide is selected from the group consisting of CaO, MgO, and ZnO, or a mixture thereof.

36. The hose as claimed in claim 30, wherein the plasticizer is selected from the group consisting of a mineral oil plasticizer, a polymer plasticizer, and an ester plasticizer, or a mixture thereof.

37. The hose as claimed in claim 30, wherein the adhesive comprises a tackifier and/or an adhesion promoter.

38. The hose as claimed in claim 29, wherein the amount present of the mixture ingredients for the rubber mixture of the internal layer and of the adhesive layer and of the external layer is from 50 phr to 400 phr.

39. The hose as claimed in claim 1, wherein an additional adhesion promoter is present between the internal layer and the adhesive layer.

40. The hose as claimed in claim 1, wherein the internal layer and the adhesive layer, free from any additional adhesion promoter application, form an adhesive bond in that an adhesive admixed with the rubber mixture of the internal layer and adhesive layer is exclusively responsible for the adhesion between the two layers.

41. The hose as claimed in claim 1 for transporting a liquid.

42. The hose as claimed in claim 41 for transporting an oil.

43. The hose as claimed in claim 42 for transporting an engine oil, transmission oil, hydraulic oil, or power-steering-system oil.

44. The hose as claimed in claim 41 for transporting a fuel.

45. The hose as claimed in claim 1 for transporting a gas with or without any additives.

46. The hose as claimed in claim 45 for transporting clean air.

47. The hose as claimed in claim 45 for transporting air contaminated by engine oil, by fuel vapor, by fuel condensate, by exhaust gas or by blow-by gases.

48. The hose as claimed in claim 45 for transporting air under static or cyclic superatmospheric pressure.

49. The hose as claimed in claim 45 for transporting air when there is relative movement of hose nozzles with respect to one another.

50. The hose as claimed in claim 45 being a charge-air hose.

51. The hose as claimed in claim 1, wherein the hose is a linear hose, curved hose, or distribution hose, respectively, with a smooth and/or folded surface.

52. The hose as claimed in claim 1 as a hose in a hose arrangement comprising the hose and at least one additional component selected from the group consisting of a Henn connector, with a VDA coupling, with a pipe nozzle with securing elements, or with abrasion protection, or with a hose clamp.

53. A hose for producing a hose as claimed in claim 1, wherein the internal layer made of the aminically crosslinkable rubber mixture and the adhesive layer made of the peroxidically crosslinkable rubber mixture are formed in succession via extrusion, with attendant subsequent finishing of the hose.

54. A hose for producing a hose as claimed in claim 1, wherein the internal layer made of the aminically crosslinkable rubber mixture and the adhesive layer made of the peroxidically crosslinkable rubber mixture are formed via coextrusion, with attendant subsequent finishing of the hose.

55. A hose for producing a hose as claimed in claim 1, wherein the internal layer made of the aminically crosslinkable rubber mixture and the adhesive layer made of the peroxidically crosslinkable rubber mixture are respectively formed via calendering, with attendant subsequent finishing of the hose.

56. A process for producing a hose as claimed in claim 2, wherein the unvulcanized hose made of internal layer and adhesive layer is vulcanized without reinforcing layer and without external layer.

57. A process for producing a hose as claimed in claim 5, wherein an unvulcanized hose made of internal layer and adhesive layer is further processed with the reinforcing layer and with the external layer, with attendant final vulcanization.
